(19) United States
(12) Patent Application Publication
(10) Pub. No.: US 2017/0229703 A1
(43) Pub. Date: Aug. 10, 2017

(54) METHOD OF PREPARATION A BATTERY ELECTRODE BY SPRAY COATING, AN ELECTRODE AND A BATTERY MADE BY METHOD THEREOF

(71) Applicant: ACADEMIA SINICA, Taipei City (TW)

(72) Inventors: Chih-Wei CHU, Taipei City (TW); Lain-Jong LI, Taipei City (TW); Kumar PUSHPENDRA, Taipei City (TW); Lung-Hao HU, Taipei City (TW)

(73) Assignee: ACADEMIA SINICA, Taipei City (TW)

(21) Appl. No.: 15/501,634

(22) PCT Filed: Aug. 7, 2014
(86) PCT No.: PCT/US2014/050043

§ 371 Date: Feb. 3, 2017

(51) Int. Cl. H01M 4/04; H01M 4/58; H01M 4/38; H01M 4/505; H01M 4/36; H01M 4/587

(52) U.S. Cl. CPC H01M 4/0419; H01M 4/364; H01M 4/587; H01M 4/38; H01M 4/505; H01M 4/5815

(57) ABSTRACT

The present invention provides a method of preparing a battery electrode, comprising: (a) providing electroactive particles; (b) mixing the electroactive particles with a graphene-based material to form a composite; and (c) spray coating the composite onto a substrate to form the battery electrode; wherein the percentage of the electroactive particles to the graphene-based material is 40-95 wt %. Furthermore, the present invention provides a high performance battery electrode and lithium sulfur battery or Lithium Metal Oxide-Sulfur battery.

### BACKGROUND OF THE INVENTION

1. Field of the Invention

The present invention relates to a method of preparing a battery electrode. More particularly, the present invention relates to a method by spray coating for a battery electrode, which is applied in a lithium-sulfur battery.

2. Description of Related Art

The strong demand for the next generation energy-storage materials and devices is exceptionally essential because energy storage devices and renewable power generation will be hard to achieve without those materials. In the past two decades, high energy density of rechargeable batteries had transformed their shape and size to serve for portable electronics. The emergent need for sustainable and clean energy attracted critical attention because of their great applications in portable electronic devices and electric vehicles etc. Pronounced effort had been devoted to developing feasible lithium-sulfur batteries due to their high specific energy and relatively low cost. Lithium-sulfur batteries had been well-thought-out to convey substantial developments to the future high energy storage in terms of higher specific capacity and cost saving. The theoretical limit of specific capacity for sulfur cathode is nearly 1675 mAh/g, which is more considerably advanced than the conventional oxide-based cathodes normally used in lithium ion batteries. Sulfur-based cathode gives a specific energy about 2600 Wh/kg.

Graphene-sulfur composite for Li—S batteries has been proven as an excellent cathode material in energy storage devices because of very high theoretical/experimental capacity over presently available counterparts. The prime challenges associated with graphene-sulfur cathodes are structural degradation, poor cycle performance and instability of the solid-electrolyte interphase caused by the large volume expansion of S during cycling. Even after the tremendous advancement in unraveling various other problems in these batteries, it still exhibits significant capacity decay during cycling. Boosting up the energy density of lithium batteries with low cost materials and technology has become a crucial focus of materials research due to the utmost and growing needs of energy storage for grid scale applications.

Poly(ethylene glycol) (PEG) coated submicrometer sulfur particles were wrapped with carbon black decorated graphene sheets to form the PEG-S/graphene composite cathode activity of sulfur. All these factors contribute to improved specific capacities of sulfur and a favorable cycle life of 100 cycles. However, the inactive components (PEG, graphene, and carbon black) take up too much of the composite, and thus are not beneficial to achieve a high sulfur content (H. Wang et, al. 2011). To reduce the content of inactive materials, a one-pot scalable method was developed to synthesize a S/graphene composite using hydrothermal methods (S. Evers et. al. 2012). Although the sulfur content in the final composite can reach up to 87 wt %, the initial capacity only reaches to 705 mAhg⁻¹. Manthiram developed a carbon-Li₂S-Carbon sandwiched electrode, where the electrode exhibits improved cycle life time. However, the carbon layers involve carbon nanotubes and graphene oxide sheets, which makes the electrode fabrication process complicated (G. Zhou et. al. 2014).

In addition, US Patent No. 20120088154 disclosed a rechargeable lithium-sulfur batteries having a cathode that includes a graphene-sulfur nanocomposite can exhibit improved characteristics. The graphene-sulfur nanocomposite can be characterized by graphene sheets with particles of sulfur adsorbed to the graphene sheets. Graphene-sulfur nanocomposite powders, synthesized by 80 wt % graphene-sulfur nanocomposite powder, 10 wt. % SP-type carbon black, and 10 wt. % polyvinylidene difluoride (PVDF) dissolved in N-methyl-2-pyrrolidone (NMP) were combined to form a slurry. However, the electrode slurry disclosed in US Patent No. 20120088154 is cast instead of spray coated onto Al foil, and the use of conductive carbon black costs a lot. U.S. Pat. No. 6,358,643 disclosed a method of producing lithium-sulfur battery including the active sulfur, the electronically conductive material (e.g. carbon black), and a dispersing agent were stir-mixed in an appropriate solvent until a slurry was formed, and cathodes may be coated with the slurry using several variations of a Mayer rod method or using spray coating or other suitable method. Spray coating was performed with an airbrush. Substrates such as carbon paper or Al foil substrates were coated by spray coating. However, this prior art did not use any graphene-based materials, but was required to use conductive carbon black to increase conductivity. Accordingly, the lithium-sulfur battery with suitable materials, simple process, higher energy density, and cost saving is needed for industry.

In addition to graphene-sulfur composite for a positive electrode in Li—S battery, the same spraying technology can be used to prepare graphene-MoS₂ (or WS₂) composite as a negative electrode for Li ion battery since MoS₂ or WS₂ is also a high capacity anode material.

### SUMMARY OF THE INVENTION

A primary objective of the present invention is to provide a method of preparing a battery electrode applied in a lithium-sulfur battery.

To achieve the foregoing objective, the present invention provides a method of preparing a battery electrode, comprising: (a) providing electroactive particles; (b) mixing the sulfur-containing particles with a graphene-based material to form a composite; and (c) spray coating the composite onto a substrate to form the battery electrode; wherein the percentage of the electroactive particles to the graphene-based material is 40 to 95 wt %.

Preferably, the electroactive particles possess high capacity, and the size of the electroactive particles is from 100 nm to 10 μm.

Preferably, the electroactive particles are sulfur, MoS₂, or WS₂ or combination thereof.

In a preferred embodiment of the present invention, the step (b) is performed in a solvent, and the solvent comprises NMP, DMF, alcohol or combination thereof.

In a preferred embodiment of the present invention, a binder is added in step (b) to form a slurry, and the hinder is PVDF.

Preferably, the slurry comprises 36 wt %-90 wt % electroactive particles based on the total amount of the slurry.

Preferably, the substrate is heated to 50-100° C. before spray coating.

Preferably, the substrate is a current collector, and the current collector is made by aluminum, copper or graphene electrodes.

Preferably, the thickness of the composite coated onto the substrate is 10-200 μm, preferably 20-25 μm.

Preferably, the graphene-based material comprises graphene.

Preferably, the graphene is an electrochemically exfoliated graphene.

In another aspect of the present invention, the step (b) and step (c) is performed repeatedly by replacing different composite of the step (b) to form multiple layers on the substrate.

Preferably, the method of preparing a battery electrode in the present invention is performed without a conductive particle or a conductive carbon black.

Preferably, the battery electrode is a cathode or an anode.

Furthermore, the present invention provides a battery electrode, which is made by aforementioned methods.

In addition, the present invention also provides a battery, comprising a battery electrode described above.

Preferably, the battery is a lithium-sulfur battery if the graphene-S composite is used as the cathode.

Preferably, the battery is a Lithium Metal Oxide-Sulfur battery if the graphene-S composite is used as an anode.

Preferably, the battery is a Lithium Metal Oxide—MoS₂ (or WS₂) battery if the MoS₂-graphene (or WS₂-graphene) composite is used as an anode.

This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

Since the process can be done at low temperature, it is suitable for fabrication of battery electrodes on flexible substrates such as polymers or papers. A flexible Lithium Metal Oxide-graphene Sulfur battery is fabricated and demonstrated to light up a LED.

Many of the attendant features and advantages of the present invention will becomes better understood with reference to the following detailed description considered in connection with the accompanying drawings.

### BRIEF DESCRIPTION OF THE DRAWINGS

The present description will be better understood from the following detailed description read in light of the accompanying drawings, where:

FIG. 1(a) is a schematic flowchart of slurry sprayed onto the Al foil;

FIG. 1(b) is a TGA curve diagram illustrating a weight loss of S particles in the slurry;

FIG. 2 is a SEM cross-section image for the sprayed layer of ECG/S;

FIG. 3 is a SEM top-view for ECG wrapped micro/nano S particles;

FIG. 4 illustrates a first cycle charge-discharge curve of ECG/S with the density of 50 mA/g;

FIG. 5 illustrates a cycle life test curve with the density of 400 mA/g (about 0.7 C-1 C);

FIG. 6 illustrates a rate capability test curve for ECG/S cathode with the density of 800 mA/g;

FIG. 7 illustrates a first cycle charge-discharge curve of the electrode of ECG:MoS₂:binder=8:2:2 and the electrode of MoS₂:binder=8:4 between 0.1V and 3V for the electrochemical performance of anode; and

FIG. 8 illustrates a flexible battery fabricated with a Lithium Metal Oxide cathode and a graphene-Sulfur anode by invented spraying process, where the battery can light up a LED.

### DESCRIPTION

Details of the objects, technical configuration, and effects of the present invention will be described more fully hereinafter with reference to the accompanying drawings, in which exemplary embodiments of the invention are shown. The like reference numerals indicate the like configuration throughout the specification, and in the drawings, the length and thickness of layers and regions may be exaggerated for clarity. The technical content of the present invention will become apparent by the detailed description of the following embodiments and the illustration of related drawings as follows. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Various embodiments will now be described more fully with reference to the accompanying drawings, in which illustrative embodiments are shown. The inventive concept, however, may be embodied in various different forms, and should not be construed as being limited only to the illustrated embodiments. Rather, these embodiments are provided as examples, to convey the inventive concept to one skilled in the art. Accordingly, known processes, elements, and techniques are not described with respect to some of the embodiments.

The singular forms “a”, “and”, and “the” are used herein to include plural referents unless the context clearly dictates otherwise.

The invention is described more fully hereinafter with reference to the accompanying drawings, in which embodiments of the invention are shown. This invention may, however, be embodied in many different forms and should not be construed as limited to the embodiments set forth herein, Rather, these embodiments are provided so that this disclosure is thorough, and will fully convey the scope of the invention to those skilled in the art.

One objective of the present invention is to obtain a high quality graphene-S composite to serve as a cathode in Li—S batteries or an anode for Lithium Metal Oxide-sulfur batteries. It's demonstrated by a simple physical mixture of graphene sheets and S particles in NMP/DMF followed by ultrasonication and spray coating process at low temperature. The thickness of sprayed materials can be easily controlled from 10-200 μm by changing the concentration, preferably 20-25 μm thick layered material in the present invention. Moreover, the sprayed and obtained graphene-sulphur composite, prepared by the present invention, shows much better stability, easy in handling and is a single step process. The present invention provides an efficient approach to obtain a high quality, cost-effective and scalable product to serve as a cathode (graphene+S particles) for Li—S batteries, which may pave a way toward future energy storage applications including solid and flexible batteries. The advantage of graphene-S composite by spraying coating process could also serve as electrodes in versatile applications, such as printed electronics (i.e., touch-panel), flexible electronics (i.e., solar cell, organic light-emitters) etc.

To achieve the foregoing objective, the present invention provides a method of preparing a battery electrode, comprising: (a) providing electroactive particles; (b) mixing the electroactive particles with a graphene-based material to form a composite; and (c) spray coating the composite onto a substrate to form the battery electrode; wherein the percentage of the electroactive particles to the graphene-based material is 40-95 wt %.

Furthermore, the present invention provides a battery electrode, which is made by aforementioned methods.

In addition, the present invention also provides a battery, comprising a battery electrode described above.

The following descriptions are provided to elucidate certain aspects of the present invention and to aid those of skilled in the art in practicing this invention. These Examples are merely exemplary embodiments and in no way to be considered to limit the scope of the invention in any manner.

### Material and Methods

A method of preparing a battery electrode disclosed by the present invention will he described in further detail with reference to several aspects and examples below, which are not intended to limit the scope of the present invention.

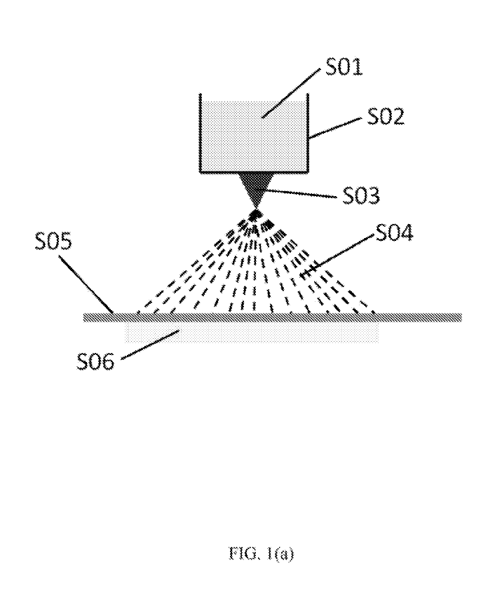

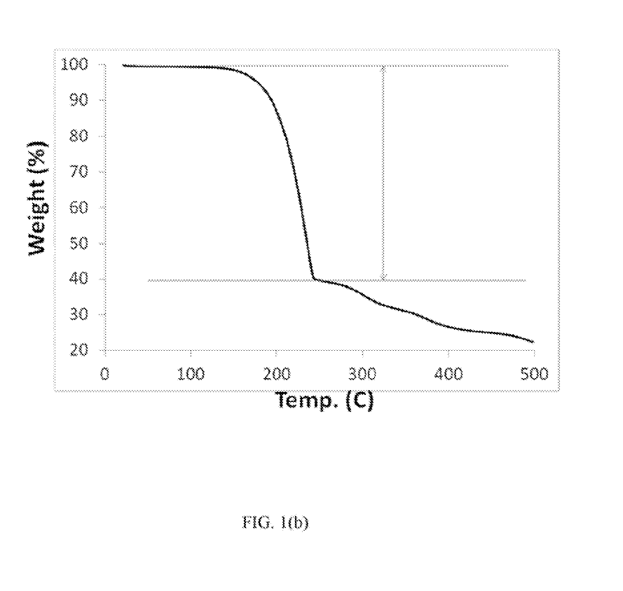

The commercial bulk sulfur material is wet-grinded by the high speed grinder with different sizes of grinding beads to form micro/nano sulfur particles. The grinded S particles with high capacity are from 100 nm to 10 μm, and physically mixed with electrochemically exfoliated graphene (ECG), which is made from TW Patent Application No. 100115655, or other graphene based materials with various weight percentages (70-90 wt % solid content in NMP/DMF media). Then, certain amount of binder is added to form slurry, and thus the content of sulfur can reach 36-90 wt % based on the total amount of the slurry. Please refer to FIG. 1(a), a container S02 for the sprayed slurry S01, which includes micro/nano S particles, ECG, an organic solvent and a binder, and spray coating was performed by a nozzle S03. An airbrush or a mist S04 is formed by the nozzle spray, and the slurry is directly sprayed onto a substrate or a current collector S05, such as Al foil, with the help of Ar/N₂ as carrier gas while keeping Al foil at certain temperature. In addition, the Al foil is heated to certain temperature by a heater S06, and the slurry is produced without adding a conductive agent, such as Super P or KS6, or a conductive carbon black. In the present invention, no conductive additive is needed through the whole process although it can be also added in.

### EXAMPLE 1

### Preparing the Graphene Sulfur-based Composite Material

The preparation of 64 weight % sulfur electrode is described here. The sulfur particles, graphene and PVDF binder are mixed in the weight ratio 8:2:2, where the sulfur content in the electrode is estimated to be 8/12=66.6 wt %. In order to know the real amount of S of the end product, the TGA is used to measure the S content of the sample 1 to 3, and the result 64 wt % from TGA is consistent with the estimation. FIG. 1(b) is a TGA curve diagram illustrating a weight loss of S particles in the slurry of sample 1. It shows that the sulfur particles in the electrode are around 64 wt % based on the total amount of the slurry, which is measured by Thermal Gravimetric Analysis (TGA).

### EXAMPLE 2

### The Spraying Process of Mixing ECG with Micro/Nano S Particles

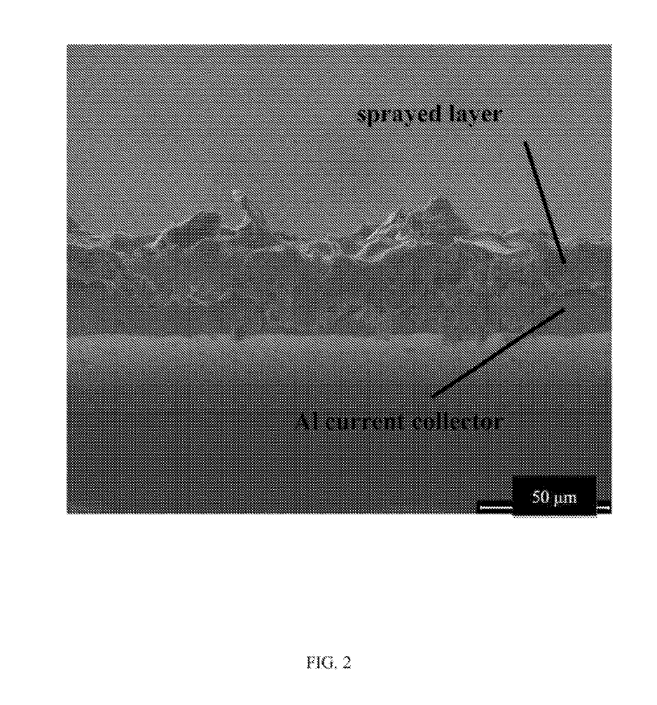

Commercial S bulk material is wet-grinded into micro and nano size using a mechanical grinder. The size of the grinded sulfur particles with high capacity ranges from 100 nm to 10 μm. The sulfur particles were mixed with an electrochemically exfoliated graphene (ECG) dispersed in N-methylpyrrolidone (NMP) solution, the ratio of the sulfur particles to the graphene-based material is 4:1. 20 wt % PVDF is added to form slurry, and thus the content of sulfur is 64 wt % based on the total amount of the slurry. The slurry is sprayed coated onto an Al current collector heated at constant 80° C. by air spraying or related machines. The thickness of the coated composite, (ECG/S) shown in FIG. 2 is 20-25 μm.

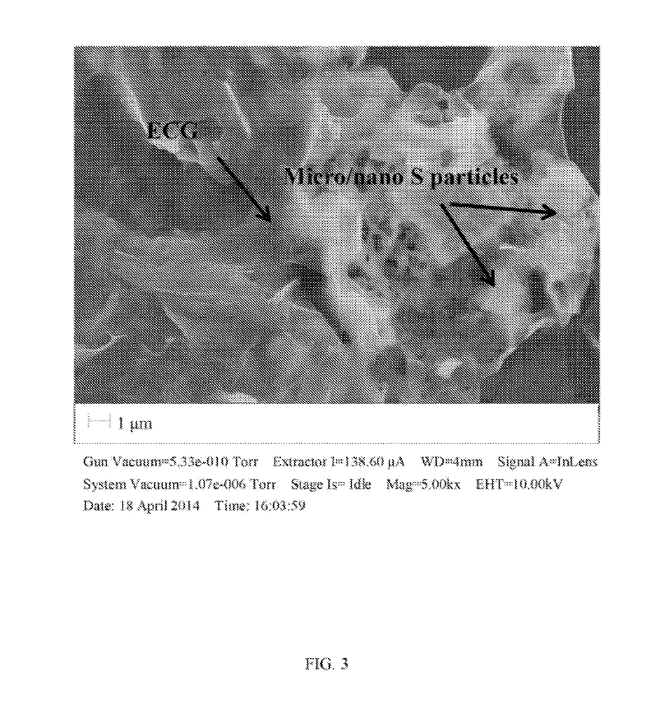

FIG. 3 displays the SEM image of top-view that shows micro/nano S particles completely wrapped by ECG. It clearly shows that the ECG completely coated onto the surface of the micro/nano S particles because of spraying coating.

Lithium is used as an anode electrode, and separators are PP/PE/PE, available from Celgard. The electrolyte is prepared by dissolving 1M Lithium bis(trifluoromethane sulfonyl) imide (LiTFSI) in a mixture of DME (dimethyl ether) and DOL (1, 3-dioxolane) with 2:1 (v/v), and then 1 wt % LiNO₃ is added. After spray coated and dried, the ECG/S cathode is assemble into 2032 coin cell for the electrochemical performance tested at the voltage window between 1.5 and 3V with a constant current.

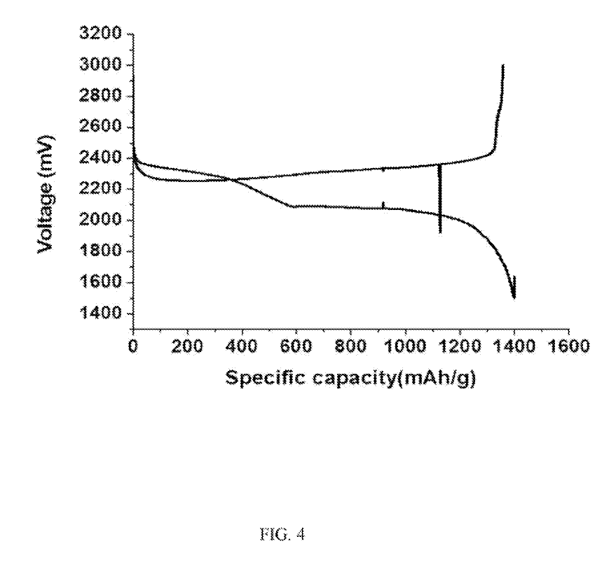

The charge-discharge curve at the first cycle is shown in FIG. 4. It shows that the specific capacity of the sprayed ECG/S cathode with the current density of 50 mA/g is able to achieve about 1400 mAh/g, and its energy density and cycle efficiency is up to 2800 Wh/g (discharge plateau is about 2V) and 100% respectively.

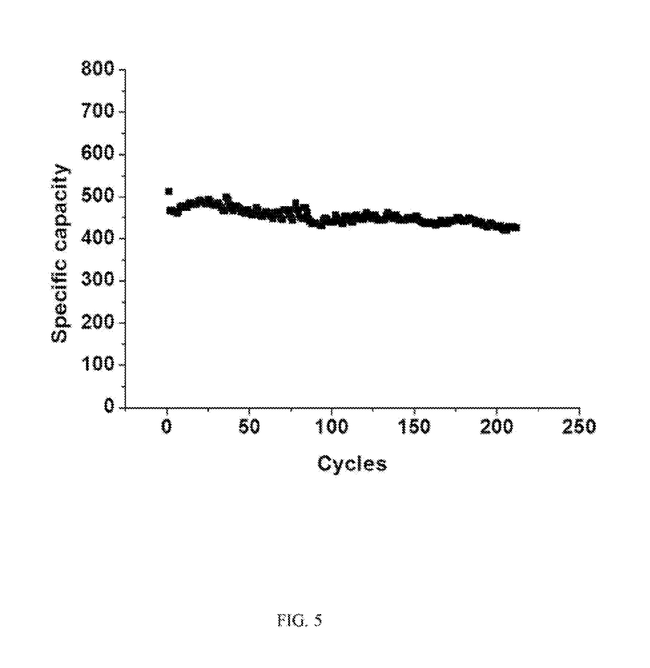

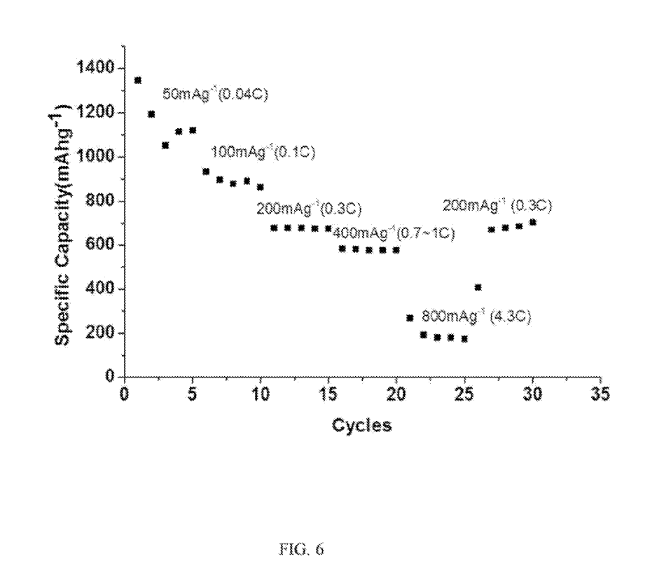

FIG. 5 illustrates a cycle life test curve at the density of 400 mA/g (about 0.7 C-1 C), and the cycle ability test of ECG/S cathode can reach 200 cycles at the current density, 400-500 mAh/g with less than 10% capacity loss. For the rate capability test ECG/S cathode shown in FIG. 6, ECG/S cathode can sustain higher current density at 800 mAh/g, and the specific capacity can achieve about 150-200 mAh/g; C-rate is 4.3 C (discharge time is 14 min). When discharging from big current (800 mAh/g) to small current (200 mA/g), the specific capacity can completely recover after the current density returned. This result demonstrates that the lithium sulfur battery keeps good electrochemical performance after charge-discharge from big current.

However, this embodiment is exemplary, but not limited thereto. For example, the thickness of the coated composite is able to be controlled by the sprayed amount of the slurry. The thickness is 10-200 μm, preferably 20-25 μm. It should be noted that spray coating disclosed in the present invention is better than blade coating since the thickness of the battery prepared by blade coating could not be thinner; the battery with thinner electrode has better conductivity, such that the volume and weight energy density (Wh/Kg) is increased in the battery and the whole battery is capable of achieving the desired effect but with lower volume.

### EXAMPLE 3

### The Spraying Process of Mixing ECG with Micro/Nano MoS₂ Particles

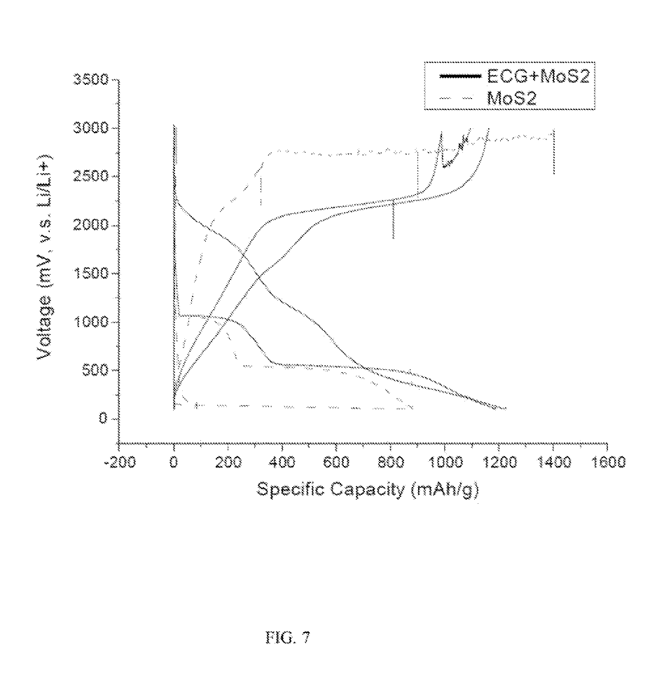

It is the same process as Example 1, but S particles are replaced with commercial MoS₂ or other materials, such as WS₂. The voltage window is changed to the range between 0.1V and 3V for the electrochemical performance of anode. The other materials and operating conditions are identical to Example 2. FIG. 7 illustrates a charge-discharge curve of the electrode ECG:MoS₂: binder=8:2:2 and the electrode MoS₂: binder=8:4 between 0.1V and 3V for the electrochemical performance of anode. This result demonstrates that the electrode with electrochemically exfoliated graphene exhibits a high capacity up to around 1200 mAh/g while the electrode without ECG shows only up to 800 mAh/g capacity.

### EXAMPLE 4

### The Spraying Process of Mixing ECG with Thiomolybdate

The thiomolybdate is normally used as a precursor which can be thermally converted to MoSx (1.5<x<3) depending on the thermolysis condition. ECG is well-mixed with alkyldiammonium-thiomolybdate or ammonium thiomolybdate in DMF/NMP and then annealed at high temperatures (600-1000° C.) to form ECG/MoSx (1.5<x<3) powder. This powder is wet-grinded by high-speed grinder to form Micro/Nano particles that is well mixed in DMP/NMP with 20 wt % of PVDF and then sprayed onto the Al current collector. The other materials, operating and testing condition is the same as those of Example 3.

In addition, in order to increase the conductivity of the lithium sulfur battery, the conductive additive, such as Ag, is considered to be coated onto the substrate; alternatively, different composites of the slurry for spray coating can be prepared to be coated onto the substrate repeatedly to form multiple layers on the substrate (i.e. current collector). For example, spray coating with graphene or graphene/Ag onto the current collector as the first layer, then, spray coating with graphene/high percentage S onto the first layer to form the second layer, and finally spray coating with graphene/low percentage S onto the second layer as the protective layer. The protective layer can be coated onto the substrate to be a final layer to prevent the sulfur particles from being diffusion to the electrolyte set forth in the battery.

### EXAMPLE 5

### Demonstration of a Flexible LiMn₂O₄-Sulfur Battery

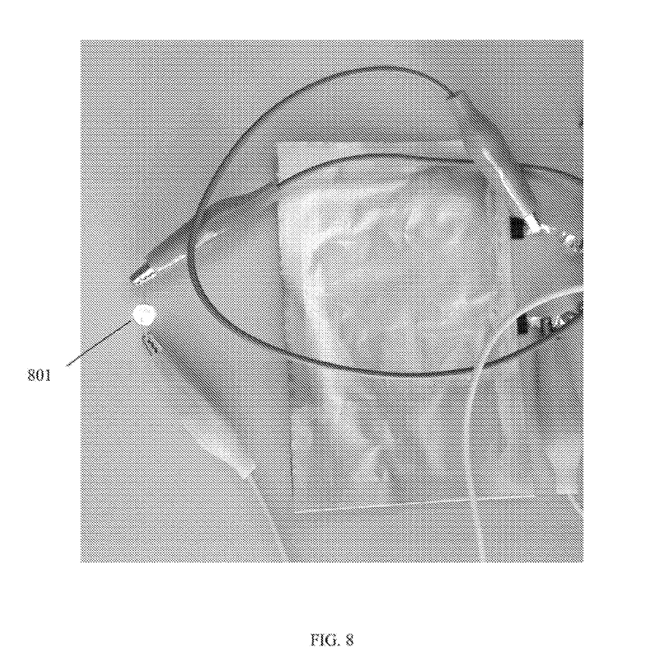

With the low temperature spraying process developed here, we fabricate a flexible battery using conventional LiMn₂O₄ as the cathode and ECG-sulfur as the anode and separators are PP/PE/PE, available from Celgard. The electrolyte is prepared by dissolving 1M Lithium bis(trifluoromethane sulfonyl) imide (LiTFSI) in a mixture of DME (dimethyl ether) and DOL (1, 3-dioxolane) with 2:1 (v/v), and then 1 wt % LiNO₃ is added. FIG. 8 shows the LiMn₂O₄—S flexible battery sealed by Al foil, where the output power is able to light up a LED 801.

In accordance with the present invention, the method of preparing a battery electrode by spray coating has the following advantages:

(1) The thickness of the sprayed materials can be easily controlled, structure is not severely damaged and the material shows superior electrochemical performance with high specific capacity.

(2) The as-prepared electrochemically exfoliated graphene-S (ECG-S) composite can be easily dispersed in organic solvents (such as NMP, DMF) to become a liquid phase solution, which can be easily processed in a large-scaled fabrication (such as air-brush, coating/spin-coating technology). In addition, the organic solvents, used in the present invention can be easily evaporated from the composite material by slow heating at 80° C., suggesting that the ECG-S composite preserve its inherited excellent electrochemical properties without containing the residual solvents.

(3) Comparing with other methods, where the processes are highly sophisticated, multi-steps and involve high-temperature reaction mechanism for a long time (12-36 hours), the present invention is a low-temperature (slightly above the room-temperature) and fast process (within 2-3 hours).

It will be understood that the above description of embodiments is given by way of example only and that various modifications may be made by those with ordinary skill in the art. The above specification, examples, and data provide a complete description of the present invention and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A method of preparing a battery electrode, comprising:
(a) providing electroactive particles;
(b) mixing the electroactive particles with a graphene-based material to form a composite; and
(c) spray coating the composite onto a substrate to form the battery electrode;
wherein the percentage of the electroactive particles to the graphene-based material is 40-95 wt %.

2. The method of claim 1, wherein the electroactive particles are sulfur, MoS₂, WS₂ or combination thereof.

3. The method of claim 1, wherein the step (b) is performed in a solvent.

4. The method of claim 3, wherein the solvent comprises NMP, DMF, alcohol or combination thereof.

5. The method of claim 1, wherein a binder is added in step (b) to form a slurry.

6. The method of claim 5, wherein the binder is PVDF.

7. The method of claim 5, wherein the slurry comprises 36 wt %-90 wt % electroactive particles based on the total amount of the slurry.

8. The method of claim 1, wherein the substrate is heated to 50-100° C. before spray coating.

9. The method of claim 1, wherein the substrate is a current collector.

10. The method of claim 9, the current collector is made by aluminum, copper or graphene electrodes.

11. The method of claim 1, wherein the thickness of the composite coated onto the substrate is 10-200 μm.

12. The method of claim 1, wherein the graphene-based material comprises graphene.

13. The method of claim 12, wherein the graphene is an electrochemically exfoliated graphene.

14. The method of claim 1, wherein the step (b) and step (c) is performed repeatedly by replacing different composite of the step (b) to form multiple layers on the substrate.

15. The method of claim 1, wherein the method is performed without a conductive particle or a conductive carbon black.

16. The method of claim 1, wherein the battery electrode is a cathode or an anode.

17. A battery electrode, which is made by claim 1.

18. The battery electrode of claim 17, which is a cathode or an anode.

19. A battery, comprising the battery electrode of claim 17.

20. The battery of claim 19, wherein the battery is a lithium-sulfur battery, Lithium Metal Oxide-sulfur battery, Lithium Metal Oxide-MoS₂ battery or Lithium Metal Oxide-WS₂ battery.
